(19) United States
(12) Patent Application Publication
(10) Pub. No.: US 2008/0049816 A1
(43) Pub. Date: Feb. 28, 2008

(54) MOBILE COMMUNICATION SYSTEM USING RECEIVING APPARATUS AND POWER SUPPLY CONTROL METHOD

(75) Inventor: Akira NAKAJIMA, Kanagawa (JP)

Correspondence Address: YOUNG & THOMPSON, 745 SOUTH 23RD STREET, 2ND FLOOR, ARLINGTON, VA, 22202, US

(73) Assignee: NEC ELECTRONICS CORPORATION, Kanagawa (JP)

(21) Appl. No.: 11/843,788

(22) Filed: Aug. 23, 2007

(30) Foreign Application Priority Data
Aug. 23, 2006 (JP) 2006-226260

(51) Int. Cl. H04B 1/707; H04B 1/16

(52) U.S. Cl. 375/148; 455/343.1; 375/E01.002

(57) ABSTRACT

A receiving apparatus includes an error detecting circuit configured to detect an error of a reception signal; an error correcting circuit configured to correct the detected error of the reception signal; a power measuring circuit configured to measure a power value of the reception signal; and a power supply control section configured to control a power supply to the error correcting circuit based on the power value. The receiving apparatus further includes a receiving circuit configured to receive a radio signal; a rake finger section configured to execute a despreading process on the signal received by the receiving circuit, and a rake combining section configured to carry out a rake combination of the plurality of signals subjected to the despreading process to generate the reception signal.

### TECHNICAL FIELD

The present invention relates to a mobile communication system.

### BACKGROUND ART

A mobile communication system of a spread spectrum system (for example, CDMA (Code Division Multiple Access) system) is known which employs a technique (rake reception) of receiving a plurality of incoming radio waves and improving a receiving sensitivity through rake combination. Specifically, a plurality of radio waves are delayed and superposed due to multi-path propagation path and then are subjected to a despreading process by a plurality of finger circuits, and supplied to a rake combining section. The rake combining section combines signals separated through despreading processes for respective paths, with respect to time and phase. At this time, the rake combining section combines the signals through a maximum ratio combining in which the separated signals are weighted based on the S/N ratios of the respective paths. The combined reception signal is subjected to error correction in an error correcting circuit and then decoded into a voice signal, an image signal, or the like.

The finger circuits, rake combining section, and error correcting circuit have complicated configurations and are large-scale circuits. Therefore, power consumption of these circuits is very large. For this reason, most of the power in a mobile communication apparatus such as a mobile phone is consumed by these circuits.

Also, in the mobile communication apparatus in the related art, a plurality of finger circuits perform a demodulating process upon every reception of a plurality of delayed signals. For this reason, the power consumption increases. For example, in a short distance communication without any obstacles on a signal transmission path, so that influence of fading and reflected waves is very little, even in a stable reception state that a reception error does not occur, all the finger circuits and a rake combining section operate continuously. In addition, an error correcting circuit always operates continuously even in no error.

In this way, as described above, the mobile communication apparatus can reduce the power consumption more if the number of finger circuits is small. However, it is required to increase the number of finger circuits to improve the reception sensitivity. Particularly, for the mobile communication apparatus adopting a W-CDMA system in which a signal is spread over a wide frequency band, it is required to use a larger number of finger circuits to perform the rake reception. Therefore, reduction of the power consumption by reducing the number of finger circuits is not practicable because the reception sensitivity is deteriorated.

A related technique of suppressing the increase in power consumption in a mobile communication apparatus is disclosed in, for example, Japanese Laid Open Patent Applications (JP-P2001-77723A: example 1, JP-P2000-174729A: example 2, and JP-P2000-124847A: example 3). A technique of limiting the number of operating finger circuits in accordance with a reception state is disclosed in these related techniques.

Specifically, a CDMA receiving terminal disclosed in the example 1 is provided with a level determining circuit for determining an intensity of an electric field of reception signal from a rake circuit (rake combining section) from a plurality of propagation paths. This level determining circuit performs a power-saving control by stopping for a certain period of time, supply of an operation clock to the finger circuit, which receives a signal from the propagation path with a low electric field level.

A COMA receiving apparatus disclosed in the example 2 is provided with a finger section power supply control circuit, which obtains a difference between adjacent levels in order from the maximum reception level. The finger section power supply control circuit performs a power-saving control on an operation of an unnecessary finger circuit in a weak level by stopping a power supply to this finger circuit.

A CDMA type mobile communication receiver disclosed in the example 3 performs a power-saving control by which the output level and a bit error rate of each finger circuit are measured based on a received pilot signal. When it is determined that a degree of a multi-path is low, an operation of the finger circuits other than the finger circuit receiving a maximum level signal and an operation of the rake combining section are stopped.

The above-mentioned related arts achieve reduction in power consumption by stopping, an operation of the finger circuit receiving a signal with a reception level equal to or lower than a threshold value and an operation of the rake combining section when the reception state is good. However, in these related arts, an error correcting circuit always operates even in the good reception state, resulting in large power consumption.

### SUMMARY

In one embodiment of the present invention, a receiving apparatus includes an error detecting circuit configured to detect an error of a reception signal; an error correcting circuit configured to correct the detected error of the reception signal; a power measuring circuit configured to measure a power value of the reception signal; and a power supply control section configured to control a power supply to the error correcting circuit based on the power value. The receiving apparatus further includes a receiving circuit configured to receive a radio signal; a rake finger section configured to execute a despreading process on the signal received by the receiving circuit, and a rake combining section configured to carry out a rake combination of the plurality of signals subjected to the despreading process to generate the reception signal.

In another embodiment of the present invention, a mobile communication system includes a mobile terminal having the above receiving apparatus; and a base station apparatus configured to carry out a radio communication with said mobile terminal by a CDMA (Code Division Multiple Access) method.

In still another embodiment of the present invention, a reception control method includes detecting an error of a reception signal; correcting the detected error of the reception signal by an error correcting circuit; measuring a power value of said reception signal; and controlling a power supply to the error correcting circuit based on the power value.

In a receiving apparatus, a mobile communication system, and a receiving method according to the present invention, the power consumption can be reduced. When a state of reception on a propagation path is favorable, the power consumption can be further reduced. Thus, the power consumption can be controlled in accordance with the state of reception on the propagation path.

### BRIEF DESCRIPTION OF DRAWINGS

The above and other objects, advantages and features of the present invention will be more apparent from the following description of certain preferred embodiments taken in conjunction with the accompanying drawings, in which:

FIG. 1 is a conceptual diagram partially showing a configuration of a mobile communication system of the present invention;

FIG. 2 is a block diagram showing a configuration of a receiving apparatus according to the embodiments of the present invention;

FIG. 3 is a block diagram showing a configuration of a power supply control section according to the embodiments of the present invention;

FIG. 4A is a diagram showing a signal level and reception time of a path signal included in a multi-path signal received by the receiving apparatus according to the present invention;

FIG. 4B is a diagram showing relationship between received data combined in a rake combining section according to the present invention and a power condition;

FIG. 5 is a flow diagram showing operation of reception and power supply control processing performed by the receiving apparatus according to the first embodiment of the present invention;

FIG. 6 is a flow diagram showing one example of processing of transition from a low power consumption mode to a normal mode performed by the receiving apparatus according to the first and second embodiments of the present invention;

FIG. 7 is a flow diagram showing one example of the processing of transition from the low power consumption mode to the normal mode performed by the receiving apparatus according to the first embodiment of the present invention; and

FIG. 8 is a flow diagram showing an operation of reception and power supply control processing performed by the receiving apparatus according to the second embodiment of the present invention.

### DESCRIPTION OF THE PREFERRED EMBODIMENTS

Hereinafter, a mobile communication system according to embodiments of the present invention will be described with reference to the attached drawings. In the drawings, same or similar components are allocated with same or similar reference numerals. In these embodiments, a mobile phone system to which a CDMA system is applied will be described as one example.

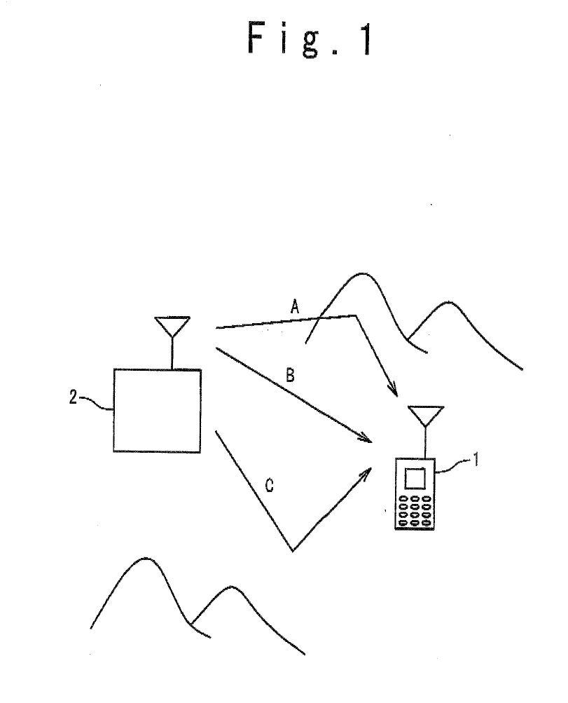

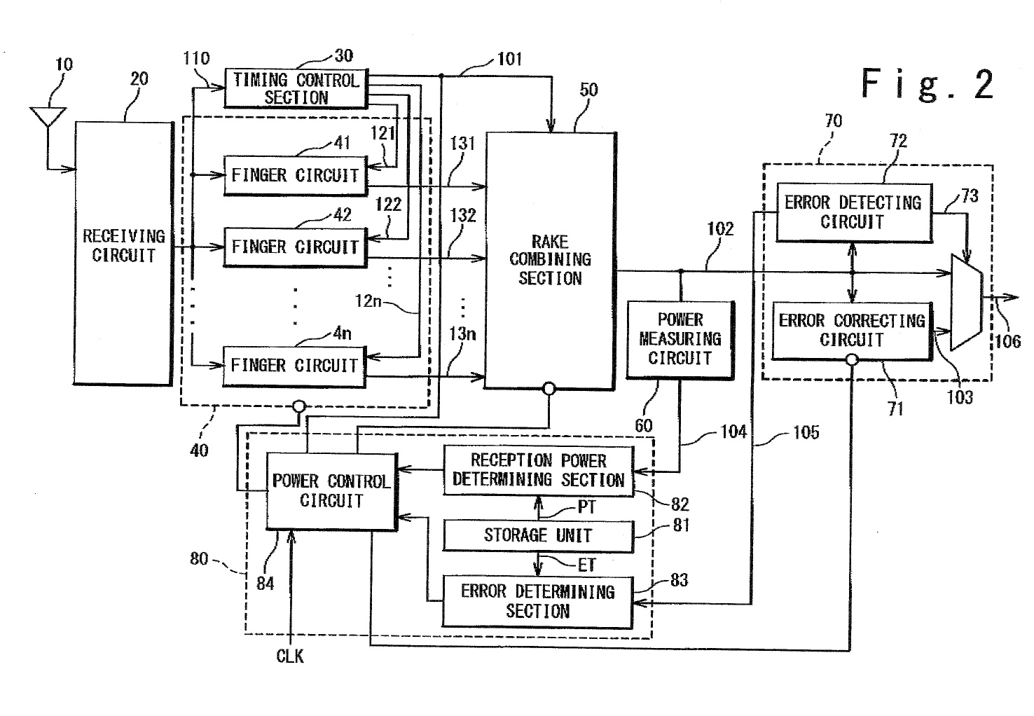

FIG. 1 is a conceptual diagram partially showing the mobile communication system according to the present invention. The mobile communication system according to the present invention includes a plurality of mobile phone terminals 1 (here, only one of the mobile terminals 1 is shown), which perform communication via a base station 2 by a spread spectrum system. The mobile phone terminal 1 includes a receiving apparatus shown in FIG. 2, and receives a radio signal transmitted from the base station 2 and acquires desired data (voices, texts, images, and the like) through a demodulating process and a decoding process.

The base station 2 has a switching function and achieves voice communication or data communication between the mobile phone terminal 1 and another mobile terminal 1 or between the mobile phone terminal 1 and a different terminal via a wired line or a wireless line. Specifically, the base station 2 carries out a digital modulating process (for example, PSK modulation) to various data such as voice data, text data, and image data, and spreads this modulated data by using a spreading code to convert into a baseband signal of a wide band. Then, the spread baseband signal is up-converted into a wireless signal of a predetermined frequency and transmitted to the mobile phone terminal 1 via an antenna. At this time, as shown in FIG. 1, the wireless signal transmitted from the base station 2 propagate through different transmission paths (A, B, C) by way of reflection by their surrounding obstacles or the like, and reaches the mobile phone terminal 1 as a combined signal of a plurality of wireless signals. Hereinafter, each of a plurality of signals propagating through different transmission paths is referred to as a path signal, and a plurality of path signals are referred to as a multi-path signal.

The multi-path signal received by the mobile phone terminal 1 is subjected to a despreading process, a rake combining process, and an error correcting process by a receiving apparatus shown in FIG. 2, and then subjected to a decoding process by a decoder (not shown). Hereinafter, detailed configuration of the receiving apparatus according to a first embodiment of the present invention will be described with reference to FIGS. 1 to 4.

Referring to FIG. 2, the receiving apparatus according to the present invention includes an antenna 10, a receiving circuit 20, a timing control section 30, a rake finger section 40; a rake combining section 50, a power measuring circuit 60, an error control section 70, and a power supply control section 80.

The antenna 10 receives a multi-path signal from the base station 2 and transmits it to the receiving circuit 20. The receiving circuit 20 down-converts the multi-path signal received by the antenna into an IF signal and then quadrature-demodulates the signal into a baseband signal. Then, the receiving circuit 20 performs A/D conversion on this baseband signal and then outputs it as a reception signal 110 to the timing control section 30 and the rake finger section 40.

The timing control section 30 analyzes a multi-path propagation characteristic of the reception signal 110, and determines a path signal to be subjected to the despreading process by the rake finger section 40 and combination timing in the rake combining section 50. Here, the multi-path propagation characteristic refers to a reception time, amplitude, and phase of the multi-path signal received by the mobile phone terminal 1. For example, the timing control section 30 includes a matched filter, a multi-path detecting unit, and a finger assigning circuit (not shown). The matched filter has a plurality of correlation units, which perform correlating processes on a pilot signal in the reception signal 110 by using a pilot channel spreading code. The multi-path detecting unit calculates the power of each path signal based on a correlation value outputted from the matched filter. The multi-path detecting unit, based on this power, obtains the reception time, amplitude (signal level, for example, S/N ratio), and phase of each path signal, and then transfers them as a delay profile 101 to the rake combining section 50. The finger assigning circuit, based on the delay profile 101, assigns the path signals to be subjected to the despreading demodulating process to respective finger circuits 41 to 4n of the rake finger section 40. At this time, the finger assigning circuit outputs timing signals 121 to 12n to the corresponding finger circuits 41 to 4n to determine an execution timing of the despreading process.

The rake finger section 40 includes a plurality of finger circuits 41 to 4n, which perform the despreading demodulating process on the respective path signals, assigned thereto by the timing control section 30 independently from one another. Each of the finger circuits 41 to 4n, integrates the reception signal 110 while calculating correlation in units of chips, by using a spreading code assigned to the mobile phone terminal 1, and then stores the integration result as symbol data in a buffer. At this time, the respective finger circuits 41 to 4n execute the despreading process on the path signals in response to the corresponding timing signals 121 to 12n, respectively.

The rake combining section 50 combines symbol data 131 to 13n outputted from the finger circuits 41 to 4n. Specifically, the rake combining section 50 performs a synchronization detecting process while using pilot symbols included in data frames for the symbol data 131 to 13n as reference phases. Next, the rake combining section 50 corrects the differences of the finger circuits 41 to 4n in despreading timing and phase, and combines the symbol data 131 to 13n. At this time, the rake combining section 50 combines the symbol data 131 to 13n by using a maximum ratio weighed with the power level (S/N ratio) included in the delay profile 101.

The symbol data combined by the rake combining section 50 are supplied as combined reception data 102 to the error control section 70 and the power measuring circuit 60. The power measuring circuit 60 measures a power value 104 of the combined reception data 102. In the present embodiment, the power measuring circuit 60 detects RSSI (Received Signal Strength Indicator) of a desired wave from the amplitude at a signal point of the combined reception data 102, and outputs it as the power value 104 to the power supply control section 80. The power value 104 may be SIR (Signal Interference Ratio) as a ratio of a desired wave to an interference wave. In this case, the power measuring circuit 60 calculates a variation at each signal point with respect to the reference phase based on the combined reception data 102 to detect the SIR.

The error control section 70 includes an error correcting circuit 71, an error detecting circuit 72, and a selector 73. The error correcting circuit 71 performs error correction on the combined reception data 102, and outputs this correction result as combined reception data 103 to the selector 73. For example, the error correcting circuit 71 is preferably a Viterbi/turbo decoder, which executes an error correcting process on the combined reception data 102 by use of a turbo code or a convolution code (Viterbi decoding). The error detecting circuit 72 detects an error rate 105 (BER (Bit Error Rate)) of the combined received data and outputs it to the selector 73 and the power supply control section 80. The selector 73 selects either of the combined reception data 102 from the rake combining section 50 and the combined reception data 103 already subjected to the error correction and supplied from the error correcting circuit 71, and outputs either one as received data 106 to a decoder (not shown). At this time, the selector 73 selects the combined reception data as the reception data 106 based on a comparison result between the error rate 105 supplied from the error detecting circuit 72 and a preset value previously set. If the error rate 105 is larger than the preset value, the combined reception data 103 is outputted as the reception data 106.

The power supply control section 80 includes a storage unit 81, a reception power determining section 82, an error rate determining section 83, and a power supply control circuit 84. The storage unit 81 stores a power condition PT and an error rate condition ET that are set as threshold values. The reception power determining section 82 compares the inputted power value 104 with the power condition PT and then outputs a comparison result to the power supply control circuit 84. The error rate determining section 83 compares the inputted error rate 105 with the error condition ET and then outputs a comparison result to the power supply control circuit 84. The power supply control circuit 84 stops the power supply to certain circuit based on the comparison results in the reception power determining section 82 and the error rate determining section 83.

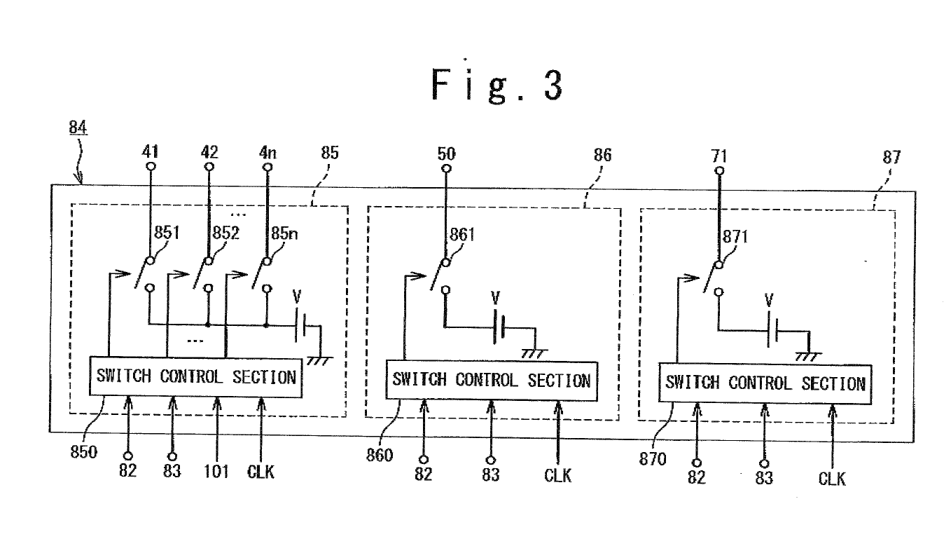

FIG. 3 is a block diagram showing a configuration of the power supply control circuit 84. Referring to FIG. 2, the power supply control circuit 84 includes a power supply control circuit 85 which controls a power supply to the finger circuits 41 to 4n, a power supply control circuit 86 which controls a power supply to the rake combining section 50, and a power supply control circuit 87 which controls a power supply to the error correcting circuit 71.

The power supply control circuit 85 includes switches 851 to 85n provided between power supply terminals of the finger circuits 41 to 4n and a power source V, and a switch control section 850 which controls turning on and off of the switches 851 to 85n independently from each other. The switch control section 850 controls the turning on and off of the switches 851 to 85n based on comparison results in the reception power determining section 82 and the error rate determining section 83 and the delay profile 101. Moreover, a clock signal CLK may be supplied to the switch control section 850 so as to measure a predetermined time. In this case, the switch control section 850 can turn on the switch that has been turned off, after a predetermined period of time to restart the power supply to the finger circuits.

The supply control circuit 86 includes a switch 861 provided between a power supply terminal of the rake combining section 50 and a power source V, and a switch control section 860 that controls turning on and off of the switch 861. The switch control section 860 controls the turning on and off of the switch 861 based on the comparison results in the reception power determining section 82 and the error rate determining section 83. Moreover, the clock signal CLK may be supplied to the switch control section 860 so as to measure a predetermined time. In this case, the switch control section 860 can turn on the switch 861 which has been turned off, after a predetermined period of time to restart the power supply to the rake combining section 50.

The power supply control circuit 87 includes a switch 871 provided between a power supply terminal of the error correcting circuit 71 and a power source V, and a switch control section 870 which controls turning on and off of the switch 871. The switch control section 860 controls the turning on and off of the switch 871 based on the comparison results in the reception power determining section 82 and the error rate determining section 83. Moreover, a clock signal CLK may be supplied to the switch control section 870 so as to measure a predetermined time. In this case, the switch control section 870 can turn on the switch 871 which has been turned off, after a predetermined period of time to restart the power supply to the error correcting circuit 71.

Next, an operation of the mobile phone system according to the first embodiment of the present invention will be described.

With configuration as described above, when a propagation path can be maintained in a favorable, stable reception state, the receiving apparatus according to the first embodiment of the present invention stops the power supply to a part of the finger circuits 41 to 4n and the error correcting circuit 71 to perform a reception operation for a desired signal. In the receiving apparatus in the first embodiment, when the reception power of the multi-path signal received by the antenna 10 is larger than a preset level and an error rate is smaller than a preset value, the power supply to all the finger circuits 42 to 4n excluding one (fore example, the finger circuit 41) is stopped. At this time, the power supply to the rake combining section 50 and the error correcting circuit 71 is also stopped.

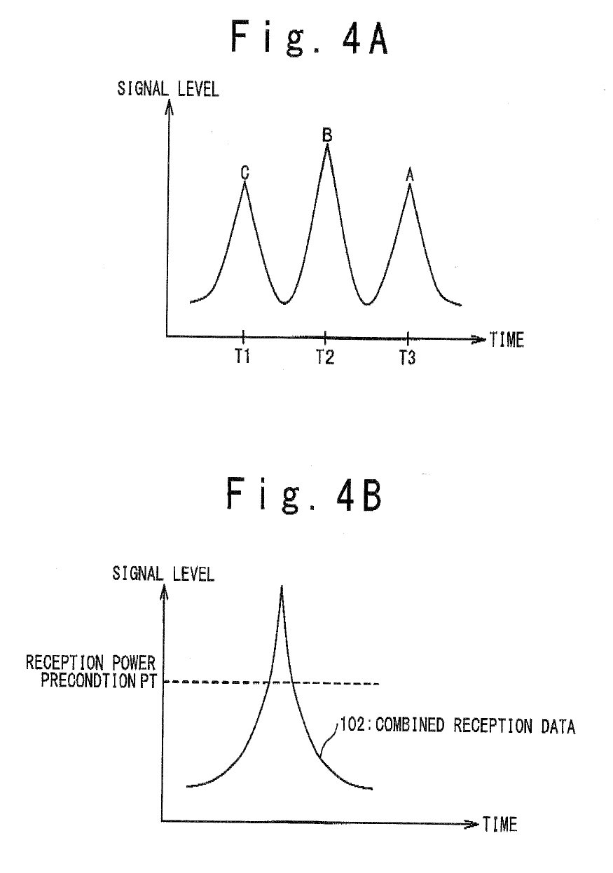

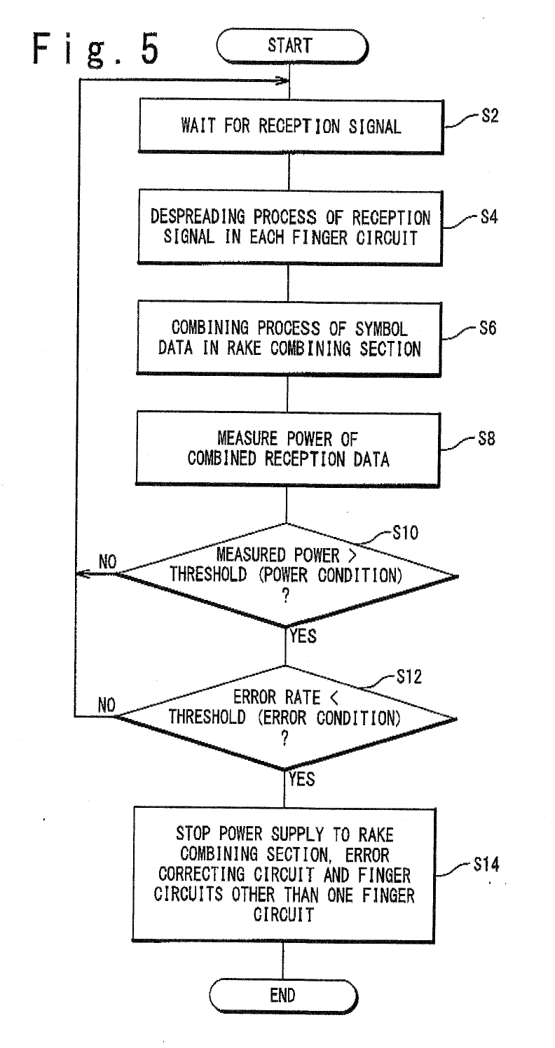

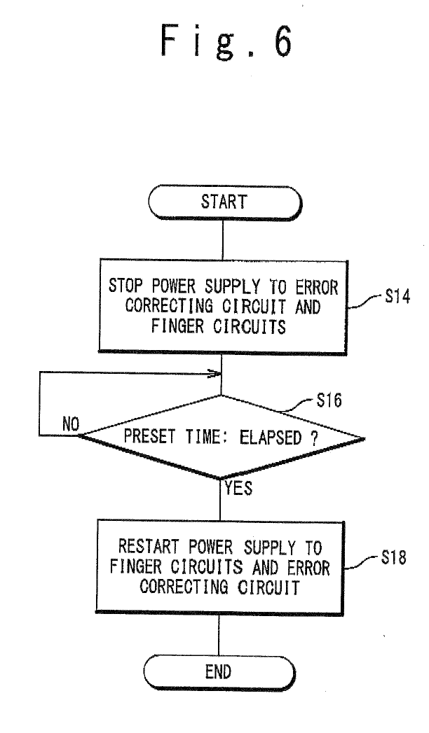

Hereinafter, referring to FIGS. 5 and 6, a receiving operation performed by the receiving apparatus according to the first embodiment will be described in detail. FIG. 5 is a flowchart showing the receiving operation and a power supply control operation in the receiving apparatus according to the present embodiment. Referring to FIG. 5, while the mobile phone terminal 1 according to the present embodiment waits a reception signal and a multi-path signal is received from the base station 2, the despreading process is executed by the finger section 40 (steps S2 and S4) Specifically, the timing control section 30 obtains a reception time, signal level, and phase of each of path signals of the received multi-path signal, and assigns the path signals subjected to the despreading demodulating process to the finger circuits 41 to 4n. For example, when the multi-path signal which propagates through transmission paths A, B, and C as shown in FIG. 1 is received, the timing control section 30 obtains the signal level and reception time of each path signal, detects each path signal as in FIG. 4A, and generates the delay profile 101. At this time, the timing control section 30 causes the finger circuits 41 to 43 to execute the despreading process on the path signals at timings corresponding to the reception times T1, T2, and T3, respectively. Here, path signals are subjected to the despreading process by the finger circuits 41 to 4n and outputted as symbol data 131 to 13n to the rake combining section 50.

The rake combining section 50 synthesizes the symbol data 131 to 13n respectively outputted from the finger circuits 41 to 4n based on the delay profile 101 (step S6). For example, the rake combining section 50 corrects and synthesizes difference in the phase and reception time between the path signals to generate the combined reception data 102 shown in FIG. 4B.

When the combined reception data 102 has been outputted from the rake combining section 50, the power measuring circuit 60 measures the power value 104 of the combined reception data 102 (step 58). The reception power determining section 82 compares this power value 104 with the power condition PT in the storage unit 81 (step S10). Meanwhile, the error detecting circuit 72 measures the error rate 105 of the combined reception data 102. The error rate determining section 83 compares this error rate 105 with the error rate condition ET in the storage unit 81 (step S12). Here, either of the steps S10 and S12 may be executed first or they may be executed simultaneously.

If the reception power determining section 82 has determined that the power value 104 is equal to or smaller than the power condition PT (No at step S10), the power supply control section 80 continues the power supply to all the connected circuits as in a usual operation. In addition, if the error rate determining section 83 has determined that the error rate 105 is equal to or larger than the error rate condition ET (No at step S12), the power supply control section 80 continues the power supply to all the connected circuits as in a usual operation. That is, if the signal level of the received multi-path signal is equal to or smaller than the threshold value and the error rate thereof is equal to or larger than the threshold value, a reception sensitivity can be improved as in the usual operation through a rake reception by the plurality of finger circuits 41 to 4n and the rake combining section 50.

On the other hand, if the power value 104 is larger than the power condition PT and the error rate 105 is smaller than the error rate condition ET (Yes at steps S10 and S12), the power supply control circuit 84 stops the power supply to the finger circuits other than the finger circuit assigned to perform the despreading process on a path signal having a maximum level of reception power. In addition, at this time, the power supply to the rake combining section 50 and the error correcting circuit 71 is also stopped (step 514). For example, if a finger circuit assigned to despread the path signal having the maximum level of reception power is the finger circuit 41, the switch control section 850 turns on only the switch 851 and turns off the switches 852 to 85n in response to control signals from the reception power determining section 82 and the error rate determining section 83. Moreover, the switch control section 860, in response to control signals from the reception power determining section 82 and the error rate determining section 83, turns off the switch 861 to cut the connection between the power source V and the power terminal of the rake combining section 50. Further, the switch control section 870 turns off the switch 871 to cut a connection between the power source V and the power terminal of the error correcting circuit 71 in response to the control signals from the reception power determining section 82 and the error rate determining section 83. In step S14, the power supply control circuit 84 supplies power to only the finger circuit corresponding to the maximum power level, but only a plurality of finger circuits may be left to perform the despreading process for power levels equal to or larger than the threshold value. In this case, the power supply to the rake combining section 50 is maintained.

In step S14 and thereafter, the multi-path signal received by the antenna 10 is despreaded by one finger circuit 41. Moreover, the symbol data 131 despreaded by the finger circuit 41 is outputted as the received data 106 from the selector 73 and decoded into voice data or image data by the decoder, not shown. Here, the power condition PT and the error rate condition ET are set such that the symbol data 131, even when outputted as the received data 106, is effectively decoded into valid voice data or image data. That is, upon transition to step S14, the multi-path signal received by the receiving apparatus at this time is a wireless signal or radio signal which is so stable that influences of fading and a reflected wave can be ignored, and becomes a substantially single path signal. The receiving apparatus according to the present invention, in such a favorable communication state that such wireless signal can be reached, can reduce the power consumption by the entire system by stopping the operations of all the finger circuits 42 to 4n excluding one finger circuit 41, the rake combining section 50, and the error correcting circuit 71.

As described above, in a favorable communication state, the receiving apparatus according to the present invention turns into a low power consumption mode in which the power consumption is reduced by stopping the power supply to the target circuits (all the finger circuits 42 to 4n excluding one finger circuit 41, the rake combining section 50, and the error control section 70). Next, a method of restarting the power supply to the target circuits from a low power consumption mode to a normal reception mode (normal mode) will be described.

FIG. 6 is a flow diagram showing one example of process of transition from the low power consumption mode to the normal mode. Referring to FIG. 6, at a step S14, when a predetermined period of time has elapsed after the power supply control circuit 84 stops the power supply to the target circuits (step S16), the power supply to the target circuits, that is, the finger circuits 42 to 4n, the rake combining section 50, and the error correcting circuit 71 is restarted. Providing a fixed period for the period of low power consumption mode in this manner permits a transition to the normal mode without requiring a complicated operation and configuration.

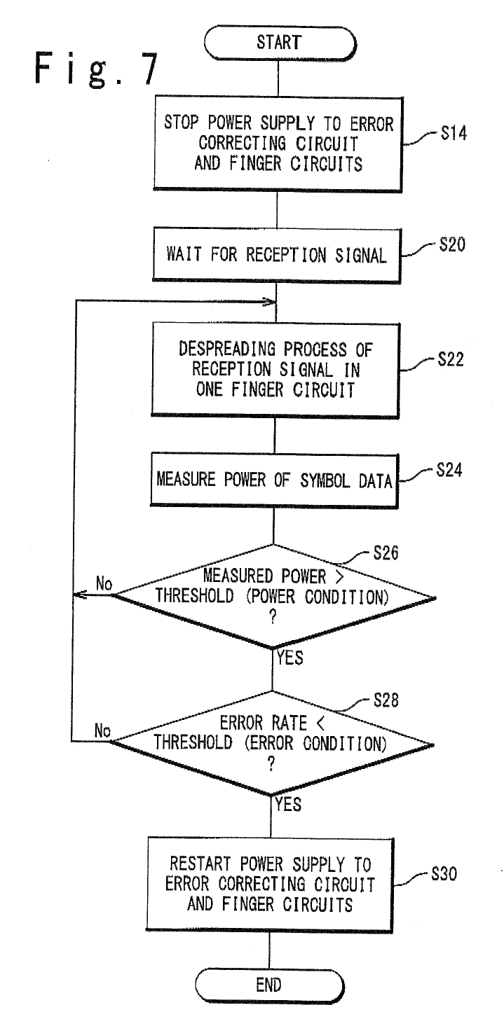

FIG. 7 is a flow diagram showing an example of the transition process from the low power consumption mode to the normal mode. Referring to FIG. 7, at a step S14 and thereafter, for the reception signal 110 based on the multi-path signal received by the receiving apparatus, only the finger circuit 41 performs the despreading process and outputs the symbol data 131 (steps S20 and S22). The power measuring circuit 60 measures the power value 104 of the symbol data 131 (step S24). The reception power determining section 82 compares the power value 104 with the power condition PT in the storage unit 81 (step S26). Meanwhile, the error detecting circuit 72 measures the error rate 105 of the symbol data 131. The error rate determining section 83 compares the error rate 105 with the error rate condition ET in the storage unit 81 (step S28). Here, either of steps S26 and S28 may be performed first, or they may be performed simultaneously.

If the reception power determining section 82 has determined that the power value 104 is equal to or smaller than the power condition PT (No at a step S26), transition to the normal mode occurs and the power supply control section 80 restarts the power supply to all the circuits, the power supply to which has been stopped in the low power consumption mode (step S30). In addition, if the error rate determining section 83 has determined that the error rate 105 is equal to or larger than the error rate condition ET (No at step S28), the power supply control section 80 restarts the power supply to all the circuits, the power supply to which has been stopped in the low power consumption mode (step S30). That is, if the signal level of the multi-path signal received is equal to or smaller than a threshold value or the error rate thereof is equal to or larger than the threshold value, the receiving sensitivity can be improved as in a usual operation through the rake reception by the plurality of finger circuits 41 to 4n and the rake combining section 50.

On the other hand, if the power value 104 is larger than the power condition PT and the error rate 105 is smaller than the error rate condition ET (Yes at steps S26 and 828), the receiving apparatus maintains the low power consumption mode and stands by for a next reception signal 110 (step S20).

With the receiving apparatus according to the present invention as described above, in the mobile communication system to which the spread spectrum is applied, only under the condition that the reception power is large and no reception error is occurring, the power supply control section 80 stops the power supply to the error correcting circuit 71, and at the same time, operates only one finger circuit 41 while stopping a power supply to the remaining finger circuits 42 to 4n. This permits, in a favorable reception state, stopping a power supply not only to the finger circuits 42 to 4n not required to perform the despreading process but also to the both circuits of the error correcting circuit 71, thus achieving reduction in the system power consumption. The power supply control section 80 may also stop the power supply to the timing control section 30 upon stopping the power supply to the rake combining section 50.

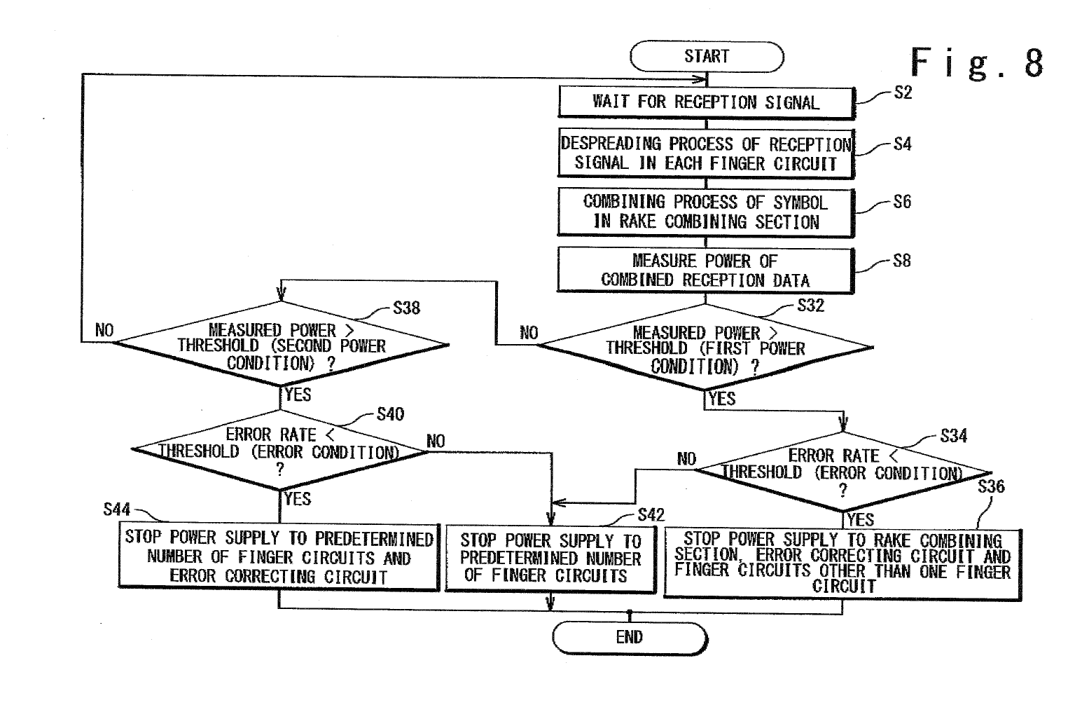

Next, an operation of the mobile phone system according to a second embodiment of the present invention. Referring to FIG. 8, a receiving operation performed by a receiving apparatus according to the second embodiment will be described in detail. A plurality of power conditions (a first power condition PT1 and a second power condition PT2 (PT1>PT2)) are set to the receiving apparatus according to the second embodiment. The power supply control section 80 in the second embodiment determines a target circuit to which power is supplied based on these conditions in a stepwise manner.

Referring to FIG. 8, an operation at steps S2 to S8 is the same as that in the first embodiment and thus omitted form the description. At the step S8, when the power value 104 is measured by the power measuring circuit 60, the reception power determining section 82 compares the power value 104 with the first power condition PT1 in the storage unit 81 (step S32). Meanwhile, the error detecting circuit 72 measures the error rate 105 of the combined reception data 102. In addition, the error rate determining section 83 compares the error rate 105 with the error rate condition ET.

If the reception power determining section 82 has determined that the power value 104 is larger than the first power condition PT1 (Yes at step S32) and the error rate determining section 83 has determined that the error rate 105 is smaller than the error rate condition ET (Yes at step S34), the power supply control circuit 64 stops the power supply to the finger circuits other than the finger circuit assigned to perform the despreading process on the path signal having the maximum level of reception power. In addition, at this time, the power supply to the rake combining section 50 and the error correcting circuit 71 is also stopped (step S36).

On the other hand, if the reception power determining section 82 has determined that the power value 104 is larger than the first power condition PT1 (Yes at step S32) and the error rate determining section 83 has determined that the error rate 105 is equal to or larger than the error condition ET (No at step S34), the power supply control circuit 84 stops a power supply to a predetermined number of finger circuits (step S42). At this time, the power supply control circuit 84 stops the power supply to the finger circuits other than the finger circuit assigned to perform the despreading process on the path signal having a predetermined level of power or higher.

If the reception power determining section 82 has determined that the power value 104 is equal to or smaller than the first power condition PT1 (No at step S32), the reception power determining section 82 compares the power value 104 with the second power condition PT2 (step S38). At this time, if the reception power determining section 82 has determined that the power value 104 is equal to or smaller than the second power condition PT2 (No at a step S38), the power supply control section 80 continues the power supply to all the connected circuits as in a usual operation.

If the reception power determining section 82 has determined that the power value 104 is lager than the second power condition PT2 (Yes at step S38) and the error rate determining section 83 has determined that the error rate 105 is smaller than the error rate condition ET (Yes at step S40), the power supply control circuit 84 stops the power supply to the predetermined number of finger circuits and also stops the power supply to the error correcting circuit 71 (step S44). At this time, the power supply control circuit 84 stops the power supply to the finger circuits other than the finger circuit assigned to perform despreading process on the path signal having the predetermined level of power or higher.

On the other hand, if the reception power determining section 82 has determined that the power value 104 is larger than the second power condition PT2 (Yes at the step S38) and the error rate determining section 83 has determined that the error rate 105 is equal to or larger than the error condition ET (No at the step S40), the power supply control circuit 84 stops the power supply to the predetermined number of finger circuits (step S42). At this time, the power supply control circuit 84 stops the power supply to the finger circuits other than the finger circuit assigned to perform the despreading process on the path signal having a predetermined level of power or higher.

It is preferable that the number of finger circuits, the power supply to which is stopped at the step S42 is equal to or larger than the number of finger circuits the power supply to which is stopped at the step S44. Moreover, it is preferable that the power level of a path signal serving as a condition for the power supply be set such that such number of finger circuits is provided. The number of finger circuits to which power is supplied at steps S42 and S44 may be fixed values previously set.

As described above, the receiving apparatus according to the second embodiment can selectively use the finger circuits, the rake combining section 50, and the error correcting circuit 71 in a stepwise manner by determination through comparison of a plurality of power conditions of the combined reception data 102 combined in the rake combining section 50. Thus, the number of finger circuits executing the despreading process and the error correction processing can be changed based on the reception level and the error rate, which permits expecting an improvement in the power consumption and the receiving sensitivity in accordance with a reception state. That is, the receiving apparatus according to the present embodiment can change, in a stepwise manner in accordance with a reception state, between the mode putting a priority on reduction in the power consumption and the mode putting a priority on an improvement in the receiving sensitivity.

The embodiments of the present invention have been described above, but detailed configuration is not limited to the embodiments described above. Thus, the present invention also includes modifications, if any, made within the range not departing from the spirit of the present invention. The operation of restarting the power supply to the circuits to which the power supply was stopped in the second embodiment, as is the case with the first embodiment, may transit to the normal mode after an elapse of a predetermined period of time, or may transit to the normal node based on the power condition PT or the error rate condition ET.

Although the present invention has been described above in connection with several embodiments thereof, it will be apparent to those skilled in the art that those embodiments are provided solely for illustrating the present invention, and should not be relied upon to construe the appended claims in a limiting sense.

What is claimed is:

1. A receiving apparatus comprising:
an error detecting circuit configured to detect an error of a reception signal;
an error correcting circuit configured to correct the detected error of said reception signal;
a power measuring circuit configured to measure a power value of said reception signal; and
a power supply control section configured to control a power supply to said error correcting circuit based on said power value.

2. The receiving apparatus according to claim 1, further comprising:
a receiving circuit configured to receive a radio signal, and
a rake finger section configured to execute a despreading process on the signal received by said receiving circuit,
wherein said reception signal is obtained based on said despreading process.

3. The receiving apparatus according to claim 2, wherein said rake finger section comprises a plurality of finger circuits configured to execute said despreading process on a plurality of signals as the radio signal received by said receiving circuit.

4. The receiving apparatus according to claim 3, wherein said power supply control section stops a power supply to at least one of said plurality of finger circuits based on said power value.

5. The receiving apparatus according to claim 3, wherein said power supply control section stops a power supply to all of said plurality of finger circuits other than one finger circuit related with a maximum power value and said error correcting circuit.

6. The receiving apparatus according to claim 3, further comprising;
a rake combining section configured to carry out a rake combination of said plurality of signals subjected to the despreading process to generate said reception signal.

7. The receiving apparatus according to claim 6, wherein said power supply control unit stops the power supply to said error correcting circuit and said rake combining section in based on said power value.

8. The receiving apparatus according to claim 1, further comprising:
a reception power determining section configured to compare said power value and a power condition as a predetermined threshold value; and
an error rate determining section configured to compare an error rate of said reception signal and an error condition as a predetermined threshold value,
wherein said power supply control unit stops the power supply to said error correcting circuit when said power value is larger than said power condition and said error rate is smaller than said error condition.

9. The receiving apparatus according to claim 8, wherein said power supply control unit restarts the power supply to said error correcting circuit when said power value is smaller than said power condition.

10. The receiving apparatus according to claim 8, wherein said power supply control unit restarts the power supply to said error correcting circuit, when said error percentage is larger than said error condition.

11. The receiving apparatus according to claim 1, wherein said power supply control unit restarts the power supply to said error correcting circuit when a predetermined time elapsed after the stop of the power supply.

12. The receiving apparatus according to claim 6, wherein said power supply control unit restarts the power supply to said error correcting circuit when a predetermined time elapsed after the stop of the power supply.

13. A mobile communication system comprising:
a mobile terminal comprising a receiving apparatus;
wherein said receiving apparatus comprises:
an error detecting circuit configured to detect an error of a reception signal;
an error correcting circuit configured to correct the detected error of said reception signal;
a power measuring circuit configured to measure a power value of said reception signal; and
a power supply control section configured to control a power supply to said error correcting circuit based on said power value, and
a base station apparatus configured to carry out a radio communication with said mobile terminal by a CDMA (Code Division Multiple Access) method.

14. A reception control method comprising:
detecting an error of a reception signal,
correcting the detected error of said reception signal by an error correcting circuit;
measuring a power value of said reception signal; and
controlling a power supply to said error correcting circuit based on said power value.

15. The reception control method according to claim 14, further comprising:
receiving a radio signal; and
performing a despreading process on the received signal by a rake finger section,
wherein said reception signal is produced through the despreading process.

16. The reception control method according to claim 15, wherein said rake finger section comprises a plurality of finger circuits,
said performing a despreading process comprises:
performing a despreading process on each of a plurality of signals of the received signal by a corresponding one of said plurality of finger circuits, and
said reception signal is produced based on said plurality of signals which have been subjected to the despreading process.

17. The reception control method according to claim 16, wherein said controlling comprises:
stopping the power supply to at least one of said plurality of finger circuits in addition to said error correcting circuit based on said power value.

18. The reception control method according to claim 16, wherein said controlling comprises:
stopping the power supply to said plurality of finger circuits other than one finger circuit related to a maximum power value, in addition to said error correcting circuit based on said power value.

19. The reception control method according to claim 16, further comprising:
generating said reception signal by rake combining said plurality of signals subjected to said despreading process by a rake combining section.

20. The reception control method according to claim 19, wherein said controlling comprises:
stopping the power supply to said rake combining section in addition to said error correcting circuit based on said power value.

21. The reception control method according to claim 14, further comprising:
setting a power condition as a preset threshold value; and
setting an error condition as a preset threshold value,
wherein said controlling comprises:
comparing said power value and said power condition;
comparing an error rate of said reception signal and said error condition; and
stopping the power supply to said error correcting circuit when said power value is larger than said power condition and said error rate is smaller than said error condition.

22. The reception control method according to claim 20, further comprising:
restarting the power supply to said error correcting circuit when said power value is smaller than said power condition.

23. The reception control method according to claim 21, further comprising:
restarting the power supply to said error correcting circuit when said error rate is larger than said error condition.

24. The reception control method according to claim 14, further comprising:
restarting the power supply to said error correcting circuit when a predetermined time elapsed after the stop of the power supply.

25. The reception control method according to claim 19, further comprising:
restarting the power supply to said rake combining section when a predetermined time elapsed after the stop of the power supply.
